(19) United States
(12) Patent Application Publication
(10) Pub. No.: US 2010/0325800 A1
(43) Pub. Date: Dec. 30, 2010

(54) Bed connection method

(76) Inventor: Xiaowei Huang, Jiaxing (CN)

Correspondence Address: LAW OFFICES OF CLEMENT CHENG, 17220 NEWHOPE STREET #127, FOUNTAIN VALLEY, CA, 92708, US

(21) Appl. No.: 12/456,965

(22) Filed: Jun. 25, 2009

(51) Int. Cl. A61G 7/005; A61G 7/00; A61G 7/018

(52) U.S. Cl. 5/618; 5/600; 5/616

(57) ABSTRACT

The present invention relates to a type of adjustable bed having junctions with equipped back support board, calf board support, front part bridge piece, back board support, rear bridge piece, thigh board support, back board support end and underframe crosstie woggle joint. The back board support has another end and is connected to the bedboard's back board woggle joint. A mattress core has a top cover and a bottom sheet, and the bottom sheet has a foot pocket having a foot pocket opening and a head pocket having a head pocket opening. The head pocket fits over an end of the back board. The foot pocket fits over an end of the calf board.

### FIELD OF THE INVENTION

The invention is in the field of electrically operated adjustable bed mechanisms. This utility invention involves a kind of adjustable bed mechanism, mainly used in adjustable electrically operated beds.

### DISCUSSION OF RELATED ART

In presently existing technology, a variety of electrically controlled adjustable beds are used for adjusting the position of a user. Unfortunately, the construction has been complicated, at high cost and large volume of space. Also, the adjustment functions are limited. Therefore, the present invention seeks to present an improved electrically controlled adjustable bed.

### SUMMARY OF THE INVENTION

The adjustable bed has electrical control of a lower thigh board portion and a back board portion. From a flat position, the lower sideboard and back board can be independently raised to a maximum inclination angle. The apparatus has a variety of parts including a back board support, and a calf board support, both of which are attached to a fixed base plate which remains prone. A bridge piece is attached to the bottom of the fixed base plate. The bridge piece has a pair of sections including the front part bridge piece rear bridge piece also called the behind part bridge piece. A back board support is made as a frame or member pressing up to support the backboard. The rear bridge piece has a connection to the thigh board support. A tail block film threading is preferably formed as a plate upon which a slot pocket shaped footboard film threading fixes on top of. The end plate films threading attaches to the footboard for securing the footboard. The head film threading analogously secures the bed headboard film threading to the headboard. A back board support end and electrical control bed underframe crosstie hinge joints. A back board support and another end of the bedboard's back board are hinge jointed. A calf board support end is connected to underframe crosstie hinge joint for moving and supporting the calf board support. The other end of the calf board has a calf board bridge piece for support.

The electrical motor assemblies include a forward electrical motor assembly and a rear electrical motor assembly. The forward electrical motor and the rear electrical motor assembly are preferably widthwise offset so that one is on the right and the other is on the left part of the under portion of the bed.

The user can adjust the thigh board through the electrical motor machinery for operating and controlling thigh board and calf board angles. The electrical machinery also drives the bridge piece, and the thigh board support to rotate on an axle. The thigh board support is supported by a roller which raises the thigh board to a continuously variable desired inclination angle gradually as the user desires. The calf board and the thigh board therefore are both continuously variable in inclination angle. The calf board support restricts the motion of the calf board so that preferably the thigh board has a maximum inclination angle of approximately 59 degrees. The preferred maximum angle between the calf board and thigh board is 113°.

The rear electrical motor assembly is connected to the front bridge piece which is secured to the fixed base plate. The front electrical motor assembly is connected to the rear bridge piece which is secured to the fixed base plate. The bed is supported on a bedboard support which in turn is supported on a pair of front rollers and a pair of rear rollers the roll on an underframe crosstie. The underframe crosstie is formed as a pair of rails or tracks upon which a front left roller, a front right roller, a rear left roller and a rear right roller roll on. The rolling of the bed is relative to the underframe crosstie is restricted by the backboard support which is pivotally connected to the underframe crosstie at a lower end and pivotally connected to a backboard bridge piece at an upper end. The first electrical machinery bridge piece forms an angle with the backboard support member. The second electrical machinery bridge piece forms an angle with the thigh board support member. The back board bridge piece is connected to the backboard, which in turn is pivotally connected to the fixed base plate.

### BRIEF DESCRIPTION OF THE DRAWINGS

FIG. 1 is a schematic of the present invention showing the structure of the adjustable bed when set level, showing the mattress on top of the adjustable structure and the headboard connection.

FIG. 2 is a schematic drawing of the present invention showing main revolution axes.

FIG. 3 is a drawing of the apparatus in raised position with raised forehead and raised thigh portion.

FIG. 4 is a drawing of the apparatus in raised position with raised forehead and raised thigh portion.

FIG. 5 is a drawing of the mechanical apparatus and structural elements that support the boards of the bed.

FIG. 6 is a side exploded view of the invention.

FIG. 7 is a bottom perspective view of the mattress assembly.

Due to the large number of moving parts, the reader is invited to review the list of elements in the drawings before reviewing the detailed description of the preferred embodiment. The drawings disclosing the present invention refer to elements listed as follows:

Bed Headboard 1

Film Threading 2

Back Board 3

Back Board Roller 4

Back Board Bridge Piece 5

Back Board Support 6

First Fixed Bridge Piece 7

Back Board Hinge 8

Fixed Base Plate 9

Front Bridge Piece 10

Rear Bridge Piece 11

Thigh Board Hinge 12

Thigh Board Bridge Piece 13

Bed Board Support 14

Thigh Board 15

Calf Board Hinge 16

Calf Board 17

Calf Board Bridge Piece 18

Film Threading 19

Footboard 20

Film Threading 21

Footboard Bridge Piece 22

Calf Board Support 23

Calf Board Support Bridge Piece 24

Aft Bedboard Support Roller 25

Thigh Board Roller 26

Thigh Board Support 27

Behind Bridge Piece 28

Second Electrical Machinery Bridge Piece 29

Rear or Second Electrical Motor Assembly 30

Front or First Electrical Motor Assembly 31

First Electrical Machinery Bridge Piece 32

Front Part Bridge Piece 33

Fore Roller 34

Underframe Crosstie 35

Back Board Support 36

Bed headboard Bridge Piece 37

Film Threading 38

First Revolution Axis 101

Second Revolution Axis 102

Third Revolution Axis 103

Fourth Revolution Axis 104

Fifth Revolution Axis 105

Sixth Revolution Axis 106

Seventh Revolution Axis 107

Eighth Revolution Axis 108

Ninth Revolution Axis 109

Tenth Revolution Axis 110

Eleventh Revolution Axis 111

Twelfth Revolution Axis 112

Thirteenth Revolution Axis 113

Fourteenth Revolution Axis 114

Fifteenth Revolution Axis 115

Sixteenth Revolution Axis 116

Seventeenth Revolution Axis 117

Foot Pocket 211

Head Pocket 212

Zipper Lower 215

Foot Pocket Opening 217

Head Pocket Opening 218

Bottom Sheet 219

Zipper Upper 225

Zipper Pull 229

Mattress Core 230

Left Flap 241

Right Flap 242

Top Cover 888

### DETAILED DESCRIPTION OF THE PREFERRED EMBODIMENT

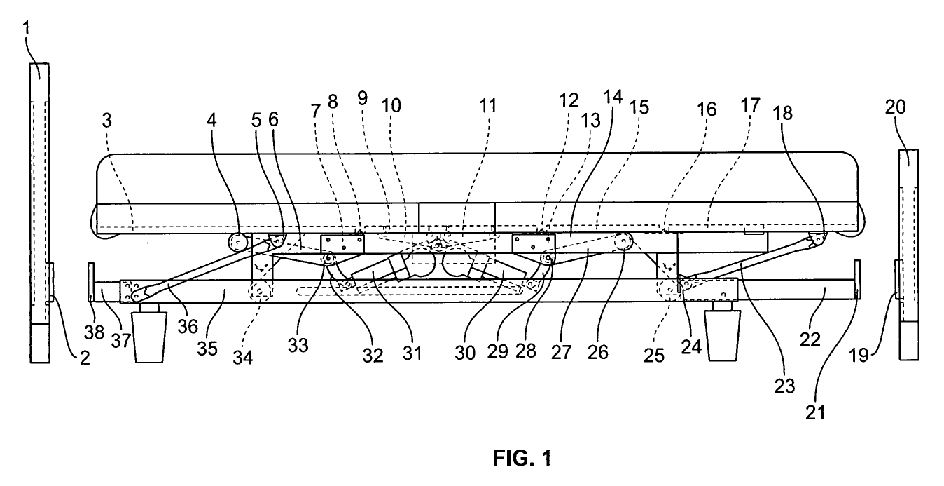

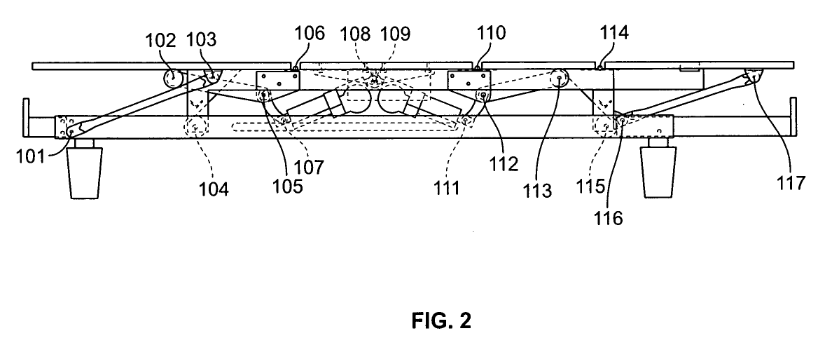

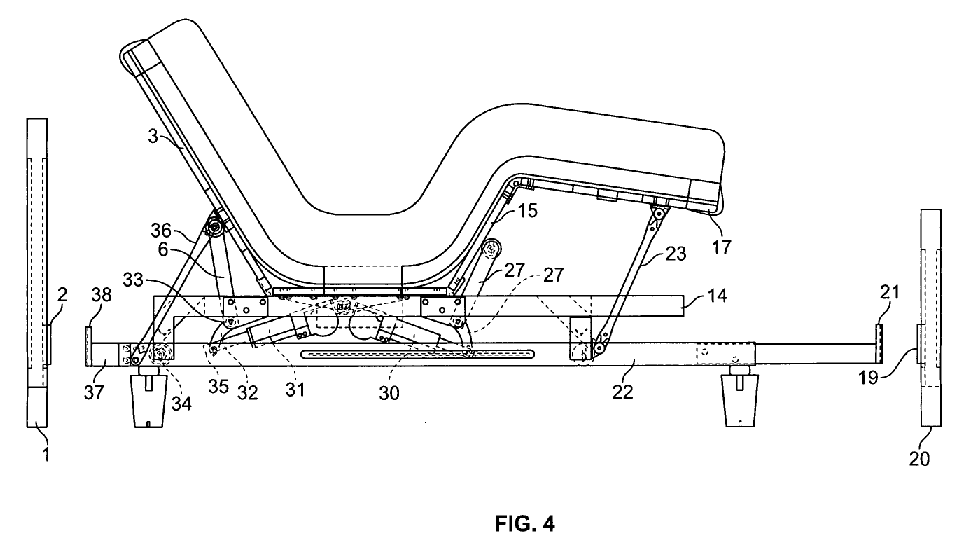

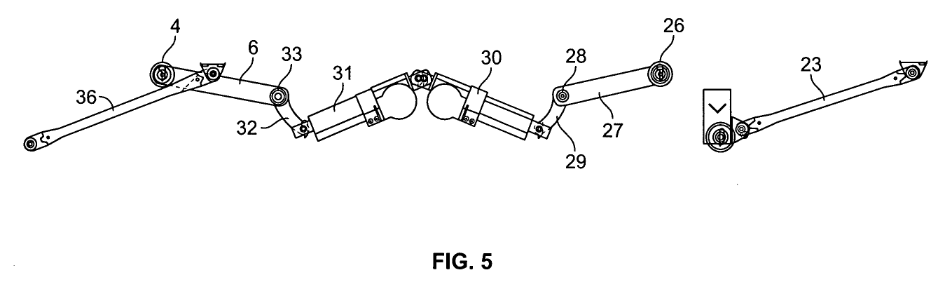

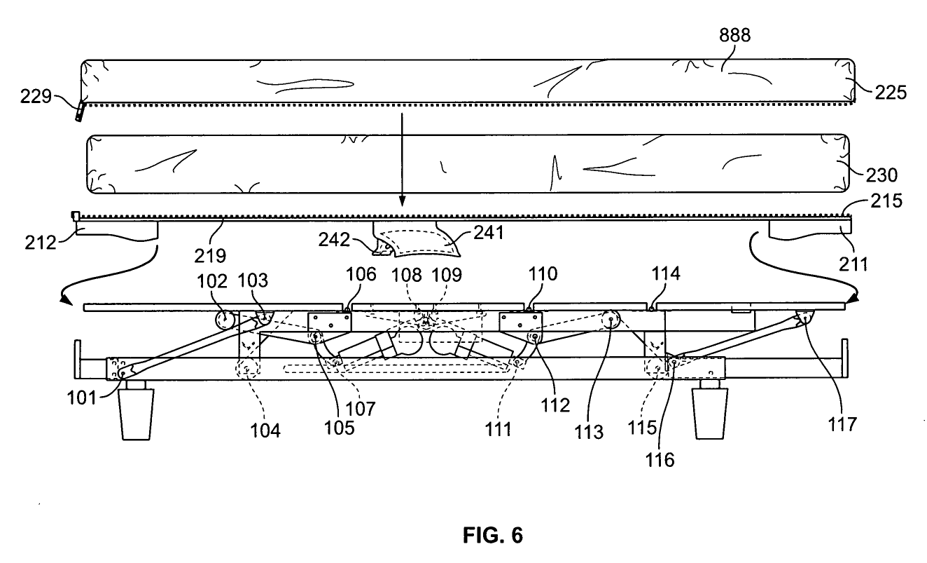

As seen in FIGS. 1-7, the preferred embodiment of the adjustable bed includes a bed headboard 1, a film threading 2 outside the bed head plate, a back board 3; a back board roller 4; a back board bridge piece 5; a back board support 6; a first fixed bridge piece 7; a back board hinge 8; a fixed base plate 9; front bridge piece 10; a rear bridge piece 11; a thigh board hinge 12; thigh board bridge piece 13; a bedboard support 14; a thigh board 15; a calf board hinge 16; a calf board 17; a calf board bridge piece 18; an outside footboard film threading 19; a footboard 20; a footboard film threading 21; a footboard bridge piece 22; a calf board support 23; a calf board support bridge piece 24; an aft bedboard support roller 25; a thigh board roller 26; a thigh board support 27; a behind bridge piece 28; a rear or second electrical machinery bridge piece 29; a rear or second electrical motor assembly 30; a front or first electrical motor assembly 31; a first electrical machinery bridge piece 32; a front part bridge piece 33; a before bedboard support, fore roller 34; an underframe crosstie 35; a back board support 36; a bed headboard bridge piece 37; and an in bed headboard film threading 38. Also, there is a controller for controlling the second electrical motor assembly in the front electrical motor assembly. The controller is preferably wired and having wires to connect to the pair of electrical motor assembly under the bed. The controller would at the very least have a power control for turning on and turned off the power, and the controller would have a first control for raising and lowering the angle of the backboard and the second control for raising and lowering the angle of the thigh board. The controllers can be made according to commonly available technology. The first electrical motor assembly and the second electrical motor assembly both have an extending arm for extending the length of the electrical motor assembly. The extending arm is also commonly available technology.

The present embodiment includes a bedboard support 14 formed as a rigid frame supporting a plurality of boards attached to a fixed base plate 9. The fixed base plate 9 permanently rigidly connected to the bedboard support 14. A first actuate bridge piece also called the rear bridge piece 11 is rigidly secured to fixed base plate 9. The first electrical motor assembly 31 is pivotally connected to actuate against the bridge piece 11 at the ninth revolution axis 109 rotation connection when the first electrical motor assembly extends or contracts its length. The first electrical motor assembly 31 actuates and is pivotally connected to a first electrical machinery bridge piece 32 at an end portion which in turn rotates on the seventh revolution axis 107 rotation connection. The angle between the first electrical motor assembly 31 and the first electrical machinery bridge piece 32 decreases when the first electrical motor assembly 31 extends in length. The first electrical machinery bridge piece 32 rotates clockwise upon length extension of the first electrical motor assembly 31.

The first electrical machinery bridge piece 32 has another end that is rigidly connected to and actuates a front part bridge piece 33. The back board support 6 end and front part bridge piece 33 have rigid permanent connection such that the angle between them does not change during extension of the first electrical motor assembly 31. The front part bridge piece 33 is pivotally connected to first fixed bridge piece 7 and pivots clockwise on the fifth revolution axis 105 rotation connection. The first fixed bridge piece 7 and bedboard support 14 are in rigid permanent connection.

The back board roller 4 installs on second revolution axis 102 in the back board support 6. Another end of the backboard has the back board bridge piece 5 with the back board 3 in permanent connection. A back board support 36 has an end and the back board bridge piece 5 pivot on the third revolution axis 103 rotation connections. The back board support 36 has another end which is a lower end that is pivotally connected to the underframe crosstie 35 and the axis is the first revolution axis 101 rotation connection. Before the bedboard support, the roller 34 installs through fourth revolution axis 104 and the roller 34 rolls on the underframe crosstie 35.

The bedboard support 14 front portion, is in rigid permanent connection with bridge piece 10 and fixed base plate 9. The Rear Electrical Motor Assembly 30 rear portion when actuated pivots in relation with the bridge piece 10 on the eighth revolution axis 108 rotation connection. The Rear Electrical Motor Assembly 30 front portion is pivotally connected and actuates a rear portion electrical machinery bridge piece 29 end on the 11th revolution axis 111 rotation connection. The latter electrical machinery bridge piece 29 has another end with the behind bridge piece 28 in rigid permanent connection. A thigh board support 27 has an end that is pivotally connected to the behind bridge piece 28, behind the bridge piece 28 on the securing bridge piece 13 via the 12th revolution axis 112 rotation connection.

The securing bridge piece 13 is rigidly connected to the bedboard support 14. The thigh board support 27 has another end upon which is installed the thigh board roller 26 via the 13th revolution axis 113. The calf board bridge piece 18 is rigidly mounted to the calf board 17 and a calf board support 23 has an end that connects to the calf board bridge piece 18 on a 17th revolution axis 117 rotation connection. The calf board support 23 has another end in pivotal connection with calf board support bridge piece 24 via a 16th revolution axis 116 rotation connection.

A calf board support bridge piece 24 is rigidly permanently connected to bedboard support 14. Below that, the bedboard support has a roller 25 installed on the 15th revolution axis 115 which is mounted on the bedboard support 14 lower portion. A back board hinge 8 connects to a lower end of the back board 3. The back board hinge 8 has another end that is connected to the fixed base plate 9. Similarly, a thigh board hinge 12 has an end that is mounted to the fixed base plate 9 in pivotal permanent connection. The thigh board hinge 12 has another end that is permanently connected to the thigh board 15. The calf board hinge 16 has an end permanently connected to thigh board 15. The calf board hinge 16 also has another end that is permanently connected to calf board 17.

The outside bed headboard film threading 2 and bed headboard 1 are in permanent connection. The bed headboard film threading 38 formed as a bracket and bed headboard bridge piece 37 are in permanent connection. The bed headboard bridge piece 37 and the underframe crosstie 35 are in permanent connection. The outside bed headboard film threading 2 and in bed headboard film threading 38 have coordinating geometry to fit together. The outside footboard film threading 19 and footboard 20 have permanent connection. The footboard film threading 21 and footboard bridge piece 22 have permanent connection. The footboard bridge piece 22 and underframe crosstie 35 are in permanent connection. The outside footboard film threading 19 and in footboard film threading 21 have coordinations such that coordinating geometry allows them to fit together.

The interface of this invention's film threading preferably uses the KD type card for simplicity and reliability. The KD card type is a known industry standard where an angled planar member secures and fits inside an angled pocket.

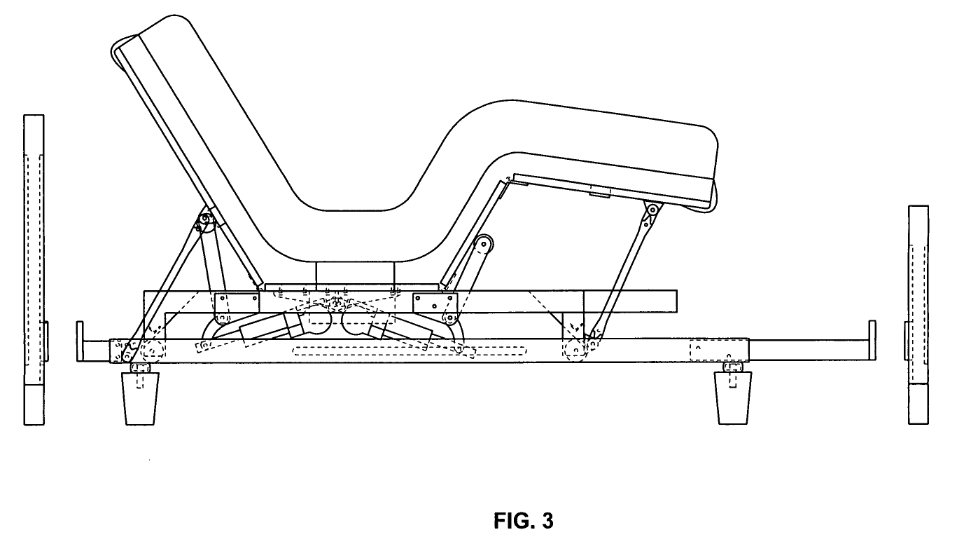

During practical application, the user uses the controller to activate and cause the Front Electrical Motor Assembly 31 rear part to rotate the bed by pushing against the ninth revolution axis 109 which rotates and drives the electrical machinery bridge piece 32 and the back board support 6 on the fifth revolution axis 105 in rotation. The front electrical motor assembly 31 is also called the first electrical motor assembly 31. The first electrical machinery 31 pushes the first electrical machinery bridge piece 32 on the seventh revolution axis 107 in rotation. The back board support 6 on back board rollers 4 rotates about the second revolution axis 102 rotation, supports the back board 3 and rotates about the sixth revolution axis 106 to increase the climb of the inclination angle gradually to a desired angle. The backboard support 6 also causes the backboard support 36 to increase the inclination angle relative to the underframe crosstie 35 that rotates on first revolution axis 101. The third revolution axis 103 provides the back board rotation to a certain angle, and also raises the roller 34 and the bedboard support. The roller 25, as the bed levels, approaches slowly toward the underframe crosstie 35 front end. This embodiment preferably establishes a back board 3 having a maximum inclination angle of 58 degrees. See FIG. 3.

Similarly, the user can control the Rear Electrical Motor Assembly 30 rear parts through the controller revolve on the eighth revolution axis 108 and actuate the electrical machinery bridge piece 29. After the front end elongation of the Rear Electrical Motor Assembly 30, the electrical machinery bridge piece 29 in turn raises the thigh board support 27 which rotates on the 12th revolution axis 112. Below the Rear Electrical Motor Assembly 30 is the bridge piece 29 rotating on the 11th revolution axis 111 which allows rotation of the electrical machinery bridge piece. The thigh board support 27 has thigh board rollers 26 that rotate about the 13th revolution axis 113. The thigh board rollers 26 support the thigh board 15 which rotates about the tenth revolution axis 110. This raises the inclination angle gradually to a desired level. Simultaneously, the calf board 17 rises in proportion to the inclination angle and moves relative to the underframe crosstie 35 which rotates about the 14th revolution axis 114.

The thigh board 15 rises to a certain angle along with the thigh board, and raises the calf board support 23 which pivots on the 16th revolution axis 116 and the 17th revolution axis 117. The thigh board 15 rises relative to the underframe crosstie 35 to a certain angle. In this preferred embodiment, the final thigh board 15 maximum inclination angle is preferably about 59°. Between the calf board 17, and the thigh board 15 the smallest inside angles is preferably about 113 degrees again as seen in FIG. 3. This embodiment Front Electrical Motor Assembly 31 and Rear Electrical Motor Assembly 30 may simultaneously or independently move the bed under the user's control. The back portion and the side portion can be activated independently. In this preferred embodiment, the revolution axis prefers usage of a bolt, pin or rivet.

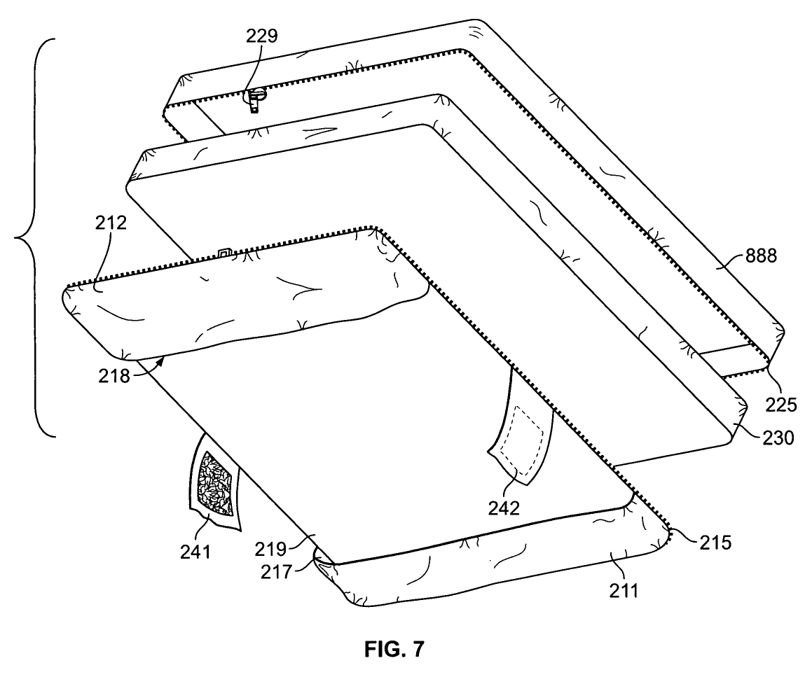

A mattress assembly means as seen in FIG. 7 can be attached to the adjustable bed. The mattress core 230 preferably made of foam is encapsulated inside a pair of covers. A top cover 888 has a top face with four sidewalls fitting over the mattress core 230. The mattress core fits over a bottom sheet 219. The bottom sheet 219 has a zipper lower portion 215 along a periphery to connect with a zipper upper portion 225 located on the top cover 888. The zipper has a zipper pull 229. The bottom sheet 219 zips together with the top cover 888 along a lower periphery going around the bottom edge of the mattress core. The zipper preferably begins and ends at the head of the mattress as shown in FIG. 7. Preferably, the bottom sheet 219 is pocketed over the underlying structure and the bed is arranged in a flat configuration before the mattress and top cover is placed over. The zipper lower portion 215 and the zipper upper portion 225 which are connected together can be made of plastic or metal.

The head pocket 212 opposes the foot pocket 211. The head pocket 212 and the foot pocket 211 are both connected to and sewn onto the bottom sheet 219. The head pocket 212 has a head pocket opening 218 which fits over the back board 3 and the foot pocket 211 fits over the calf board 17. The head pocket 212 has a head pocket opening 218 which is preferably rectangular, and the foot pocket 211 preferably has a foot pocket opening 217 which is preferably rectangular. A left flap 241 and a right flap 242 are attached to the bottom sheet 219 in the same manner. The left flap 241 and the right flap 242 can both be fitted with hook and loop tape. Preferably, the loop portion of the loop tape is disposed on an inside surface of the left flap 241 and the right flap 242. The hook portion of the hook and loop tape is preferably located on the bottom surface of the fixed base plate 9. The fixed base plate 9 may have a hook portion of the hook and loop tape made as a fabric rectangle which is stapled to the underside of the fixed base plate nine. The fabric rectangle is preferably the same size as the left and right flaps.

The fabric portions of the covering of the mattress core are preferably made of a cloth, which can be padded. A wide variety of materials can be used for the mattress core, including a soft memory foam, or a more rigid spring construction. The mattress core can be made in sections corresponding to the back board, the calf board, and the thigh board. The foot pocket 211 and the head pocket 212 can have an elastic trim passing around the foot pocket opening 217 and the head pocket opening 218.

While the presently preferred form of the system has been shown and described, and several modifications thereof discussed, persons skilled in this art will readily appreciate that various additional changes and modifications may be made without departing from the spirit of the invention, as defined and differentiated by the following claims.

1. An adjustable bed comprising:
a. an underframe crosstie;
b. a pair of bedboard support rollers supported by the underframe crosstie, which forms a track upon which roll the pair of bedboard support rollers;
c. a bedboard support supported by the pair of bedboard support rollers;
d. a fixed base plate secured to the bedboard support;
e. a back board support attached in a hinged connection to the fixed base plate;
f. a thigh board support attached in a hinged connection to the fixed base plate;
g. a calf board support attached in a hinged connection to the thigh board support; and
h. a mattress core having a top cover and a bottom sheet, wherein the bottom sheet comprises a foot pocket having a foot pocket opening and head pocket having a head pocket opening, wherein the head pocket fits over an end of the back board, wherein the foot pocket fits over an end of the calf board, wherein the top cover and the bottom sheet are joined together by a zipper, further comprising a left flap and a right flap, wherein the left flap and the right flap releasably connect to a bottom surface of the fixed base plate.

2. The adjustable bed of claim 1, further comprising:
a. a back board support member pivotally connected to the underframe crosstie at a backboard support member lower end, and pivotally connected to the bedboard support at a backboard support member upper end; and
b. a calf board support member pivotally connected to the calf board at a calf board support member upper end, and pivotally connected to the underframe crosstie at a calf board support member lower end.

3. The adjustable bed of claim 2, further comprising:
a. a first electrical machinery bridge piece in pivotal connection to the first electrical motor assembly, wherein the first electrical machinery bridge piece is configured to rotate when the first electrical motor assembly extends, wherein the first electrical machinery bridge piece is rigidly connected to the backboard support member, wherein the first electrical machinery bridge piece forms an angle with the backboard support member;
b. a second electrical machinery bridge piece in pivotal connection to the second electrical motor assembly, wherein the second electrical machinery bridge piece is configured to rotate when the second electrical motor assembly extends, wherein the second electrical machinery bridge piece is rigidly connected to the thigh board support member, wherein the second electrical machinery bridge piece forms an angle with the thigh board support member.

4. The adjustable bed of claim 2, further comprising:
a. a back board roller pivotally connected to the backboard support member at a backboard support member upper end; and
b. a thigh board roller pivotally connected to the thigh board support member at a thigh board support member upper end.

5. The adjustable bed of claim 2, further comprising:
a. a rear bridge piece connected to the fixed base plate, wherein the rear bridge piece is secured to the first electrical motor assembly;
b. front bridge piece connected to the fixed base plate, wherein the front bridge piece is secured to the second electrical motor assembly.

6. An adjustable bed comprising:
a. an underframe crosstie;
b. a pair of bedboard support rollers supported by the underframe crosstie, which forms a track upon which roll the pair of bedboard support rollers;
c. a bedboard support supported by the pair of bedboard support rollers;
d. a fixed base plate secured to the bedboard support;
e. a back board support attached in a hinged connection to the fixed base plate;
f. a thigh board support attached in a hinged connection to the fixed base plate;
g. a calf board support attached in a hinged connection to the thigh board support;
h. a first electrical motor assembly which has an extending arm for increasing length;
i. a back board support mounted under the back board, and rotationally actuated by the first electrical motor assembly to lift the backboard when the first electrical motor assembly is controlled by a controller to increase in length;
j. a second electrical motor assembly which also has an extending arm for increasing length;
k. a thigh board support mounted under the thigh board, and rotationally actuated by the second electrical motor assembly to lift the thigh board when the second electrical motor assembly is controlled by a controller to increase in length;
l. a mattress core having a top cover and a bottom sheet, wherein the bottom sheet comprises a foot pocket having a foot pocket opening and head pocket having a head pocket opening, wherein the head pocket fits over an end of the back board, wherein the foot pocket fits over an end of the calf board.

7. The adjustable bed of claim 6, further comprising:
a. a back board support member pivotally connected to the underframe crosstie at a backboard support member lower end, and pivotally connected to the bedboard support at a backboard support member upper end; and
b. a calf board support member pivotally connected to the calf board at a calf board support member upper end, and pivotally connected to the underframe crosstie at a calf board support member lower end.

8. The adjustable bed of claim 7, further comprising:
a. a first electrical machinery bridge piece in pivotal connection to the first electrical motor assembly, wherein the first electrical machinery bridge piece is configured to rotate when the first electrical motor assembly extends, wherein the first electrical machinery bridge piece is rigidly connected to the backboard support member, wherein the first electrical machinery bridge piece forms an angle with the backboard support member;
b. a second electrical machinery bridge piece in pivotal connection to the second electrical motor assembly, wherein the second electrical machinery bridge piece is configured to rotate when the second electrical motor assembly extends, wherein the second electrical machinery bridge piece is rigidly connected to the thigh board support member, wherein the second electrical machinery bridge piece forms an angle with the thigh board support member.

9. The adjustable bed of claim 7, further comprising:
a. a back board roller pivotally connected to the backboard support member at a backboard support member upper end; and
b. a thigh board roller pivotally connected to the thigh board support member at a thigh board support member upper end.

10. The adjustable bed of claim 7, further comprising:
a. a rear bridge piece connected to the fixed base plate, wherein the rear bridge piece is secured to the first electrical motor assembly;
b. front bridge piece connected to the fixed base plate, wherein the front bridge piece is secured to the second electrical motor assembly.

11. The adjustable bed of claim 10, further comprising:
a. a back board roller pivotally connected to the backboard support member at a backboard support member upper end; and
b. a thigh board roller pivotally connected to the thigh board support member at a thigh board support member upper end.

12. An adjustable bed comprising:
a. an underframe crosstie;
b. a pair of bedboard support rollers supported by the underframe crosstie, which forms a track upon which roll the pair of bedboard support rollers;
c. a bedboard support supported by the pair of bedboard support rollers;
d. a fixed base plate secured to the bedboard support;
e. a back board support attached in a hinged connection to the fixed base plate;
f. a thigh board support attached in a hinged connection to the fixed base plate;
g. a calf board support attached in a hinged connection to the thigh board support;
h. a first electrical motor assembly which has an extending arm for increasing length;
i. a back board support mounted under the back board, and rotationally actuated by the first electrical motor assembly to lift the backboard when the first electrical motor assembly is controlled by a controller to increase in length;
j. a second electrical motor assembly which also has an extending arm for increasing length;
k. a thigh board support mounted under the thigh board, and rotationally actuated by the second electrical motor assembly to lift the thigh board when the second electrical motor assembly is controlled by a controller to increase in length; and
l. a headboard;
m. a headboard bridge piece attached to the underframe crosstie; and
n. a film threading on the headboard and headboard bridge piece attaching the headboard to the headboard bridge piece.
o. a back board support member pivotally connected to the underframe crosstie at a backboard support member lower end, and pivotally connected to the bedboard support at a backboard support member upper end; and
p. a calf board support member pivotally connected to the calf board at a calf board support member upper end, and pivotally connected to the underframe crosstie at a calf board support member lower end.
q. a first electrical machinery bridge piece in pivotal connection to the first electrical motor assembly, wherein the first electrical machinery bridge piece is configured to rotate when the first electrical motor assembly extends, wherein the first electrical machinery bridge piece is rigidly connected to the backboard support member, wherein the first electrical machinery bridge piece forms an angle with the backboard support member;
r. a second electrical machinery bridge piece in pivotal connection to the second electrical motor assembly, wherein the second electrical machinery bridge piece is configured to rotate when the second electrical motor assembly extends, wherein the second electrical machinery bridge piece is rigidly connected to the thigh board support member, wherein the second electrical machinery bridge piece forms an angle with the thigh board support member;
s. a calf board bridge piece providing pivotal connection between the calf board and the calf board support member; a back board bridge piece providing pivotal connection between the back board and the backboard support member;
t. a first fixed bridge piece connected to a front part bridge piece which is in turn connected to the first electrical machinery bridge piece and the backboard support member; a thigh board bridge piece connected to a behind bridge piece which is in turn connected to the second electrical machinery bridge piece and the thigh board support member; and
u. a mattress core having a top cover and a bottom sheet, wherein the bottom sheet comprises a foot pocket having a foot pocket opening and head pocket having a head pocket opening, wherein the head pocket fits over an end of the back board, wherein the foot pocket fits over an end of the calf board.

13. The adjustable bed of claim 12, further comprising:
a. a back board roller pivotally connected to the backboard support member at a backboard support member upper end; and
b. a thigh board roller pivotally connected to the thigh board support member at a thigh board support member upper end.

14. The adjustable bed of claim 12, further comprising:
a. a rear bridge piece connected to the fixed base plate, wherein the rear bridge piece is secured to the first electrical motor assembly;
b. front bridge piece connected to the fixed base plate, wherein the front bridge piece is secured to the second electrical motor assembly.

15. The adjustable bed of claim 14, further comprising:
a. a back board roller pivotally connected to the backboard support member at a backboard support member upper end; and
b. a thigh board roller pivotally connected to the thigh board support member at a thigh board support member upper end.
